(19) United States
(12) Patent Application Publication
(10) Pub. No.: US 2008/0216972 A1
(43) Pub. Date: Sep. 11, 2008

(54) Automatically actuable side window roller blind

(76) Inventors: Bernd Starzmann, Hohengehren (DE); Matthias Maier, Esslingen (DE); Melf Hansen, Gondelsheim (DE); Herbert Walter, Ebersbach (DE)

Correspondence Address: FLYNN THIEL BOUTELL & TANIS, P.C., 2026 RAMBLING ROAD, KALAMAZOO, MI, 49008-1631, US

(21) Appl. No.: 12/075,077

(22) Filed: Mar. 7, 2008

(30) Foreign Application Priority Data
Mar. 9, 2007 (DE) 102007012281.2

(51) Int. Cl. E06B 9/68

(52) U.S. Cl. 160/310

(57) ABSTRACT

A side window roller blind for a window opening of a motor vehicle, and a method for fitting, includes a winding shaft, a roller blind web which is fastened at a first edge to the winding shaft, an extension profile which is operatively connected to a second edge of the roller blind web such that the roller blind web can be unwound from the winding shaft. An actuating device and a drive for driving the actuating device are provided. The extension profile can be displaced by the actuating device, and the drive is arranged in the region of the winding shaft.

The invention relates to a side window roller blind for a motor vehicle, comprising a winding shaft, a roller blind web which is fastened at a first edge to the winding shaft, an extension profile which is operatively connected to a second edge of the roller blind web, which edge lies opposite the first edge, such that the roller blind web can be unwound from the winding shaft by means of the extension profile, an actuating device, wherein the extension profile can be displaced by means of the actuating device, and a drive for driving the actuating device. The invention furthermore relates to a method for fitting a side window roller blind to a side door of a motor vehicle.

A side window roller blind is known, for example, from EP 1 123 824 A2, where the side window roller blind is arranged on a side door of a motor vehicle and can be extended and/or retracted in an electrically remote-controlled manner. In the retracted state, the side window roller blind largely disappears within a side door or behind a door lining of the side door. The side window roller blind comprises an extension profile via which the roller blind web can be unwound from the winding shaft. The extension profile can be moved, for example, via an actuating device, comprising a driven boom. A geared motor which is arranged in a lower region of a side door is provided for driving the boom. By means of the geared motor, the side window roller blind can be actuated in a remote-controlled manner, for example by a driver and/or a passenger in the rear of the vehicle.

The invention is based on the object of providing an automatically actuable side window roller blind which makes easy driving of an actuating device possible. It is furthermore the object of the invention to provide a method for fitting a side window roller blind to a side door of a motor vehicle.

This object is achieved by a side window roller blind for a motor vehicle, comprising a winding shaft, a roller blind web which is fastened at a first edge to the winding shaft, an extension profile which is operatively connected to a second edge of the roller blind web, which edge lies opposite the first edge, such that the roller blind web can be unwound from the winding shaft by means of the extension profile, an actuating device and a drive for driving the actuating device, wherein the extension profile can be displaced by means of the actuating device, and the drive for the actuating device is arranged in the region of the winding shaft. The arrangement of the drive in the region of the winding shaft makes it possible for the actuating device to be small. In addition, large force transmission distances can be avoided, since the drive of the actuating device is essentially arranged in the operative range thereof. A further advantage of the invention is that only a small amount of space is required within the side door for the drive and/or the actuating means, and therefore further components, such as an electrically actuable side window, speaker or the like, can easily be integrated in the side door. The invention makes it possible to obtain a particularly compact construction. The actuating device may be supplied as a preassembled constructional unit. By this means, easier handling during installation or removal can be obtained. Unlike in the prior art, there are no shafts hanging down.

Driving takes place, for example, by means of a spring motor, pneumatically, hydraulically and/or via an electric motor, with the extension profile being movable by the drive, by means of suitable actuating means, at least for unwinding the roller blind web. A mechanism in which a spring or the like serves as the mechanical energy store is referred to here as the spring motor. Rolling up of the roller blind web is possible, for example, via a spring motor integrated in the winding shaft. In other configurations, winding up can be assisted by the drive or by a further drive which is operatively connected to the winding shaft.

In one refinement of the invention, the drive can be arranged on a side door directly below a lower border of the side window. By fitting it directly below the lower border of the side window, good utilization of the space is possible. In one refinement, the winding shaft is arranged in a cassette. In this case, the drive can likewise be arranged on the cassette. In one embodiment, the winding shaft is arranged parallel to the lower border of the side window.

In a further refinement of the invention, the drive comprises an electric motor, in particular an electric geared motor. Electric motors can easily be controlled and/or regulated, and therefore automated actuation of the side window roller blind can be integrated in a simple manner into a management system for control devices present in the motor vehicle. For example, it is conceivable to couple the side window roller blind to a sensor arrangement for detecting solar radiation, with, at a definable value, the side window roller blind automatically darkening an associated side window. The gear mechanism enables the rotational speed and the torque of the electric motor to be converted into a lower rotational speed for a drive shaft.

In a further refinement of the invention, the actuating device comprises an elongated actuating means with at least one row of profilings, in particular tooth-shaped grooves and/or projections, the drive comprising an output gear for driving the actuating means, said output gear having mating profilings, in particular teeth, which correspondingly engage in an interlocking manner in the profilings of the actuating means. Teeth, cutouts, depressions, grooves, perforations, webs and the like can be provided as the profilings and mating profilings. In one refinement, the gearwheel sits directly on a drive shaft of the geared motor. The arrangement according to the invention of the drive enables the actuating means to be directly driven in the region of the winding shaft.

In a further refinement of the invention, the actuating device comprises at least one rack which is operating connected to the extension profile for a transmission of movement. Owing to the fact that the drive is arranged directly in the region of the winding shaft, the rack can be directly driven in the region of the winding shaft. This permits a good, loss-free introduction of force. In addition, a rack can thus be designed to be relatively short, with the length essentially corresponding to the extension length of the roller blind web.

In one development of the invention, the rack is flexurally elastic. As a result, it is possible to guide the rack in a suitable manner along a curved path within the side door and/or behind a door lining.

In a further refinement of the invention, the actuating device comprises a toothed cord which is operatively connected to the extension profile for a transmission of movement. A flexible force transmission means which is very elongated in relation to its thickness and by means of which both tensile and compressive forces can be transmitted is referred to as a toothed cord within the meaning of the invention. A toothed cord comprises, for example, a flexurally elastic core which is usually of cylindrical design, and a coil which is wound around the core in order thereby to form an oblique toothing. The toothed core has sufficient rigidity in order to displace the extension profile of the side window roller blind.

In another refinement of the invention, the actuating device comprises, as the actuating means, a perforated longitudinal profile, in particular a metal plate, which is operatively connected to the extension profile for a transmission of movement. In this case, the perforated plate has sufficient buckling strength in order to prevent the plate from buckling during the extension of the side window roller blind. The buckling strength can be further increased by means of corresponding profiling of the plate. In this case, the drive preferably comprises an output gear for driving the longitudinal profile, said output gear having mating profilings, in particular extensions, correspondingly engaging in an interlocking manner in the profilings of the longitudinal profile.

In another refinement of the invention, the drive is designed as a cable drive and/or perforated belt drive by means of which at least one essentially buckle-proof rod of the actuating device can be actuated for the displacement of the extension profile. For this purpose, in one refinement, the rod is operatively connected mechanically to the perforated belt.

In a further refinement of the invention, a blank of the roller blind web corresponds at least approximately to a shape of a side window. As a result, it is possible to reliably prevent sun rays from entering and/or to provide good protection against someone seeing in.

In a further refinement, an actuating element of the actuating device, in particular a rack, a toothed cord, a rod and/or a plate, is at least partially guided in a guide rail. The guide rail can be arranged, for example, on the B pillar and/or in the region of the B pillar. In this case, the actuating element acts on one end of the extension profile, which end can be designed as a type of boom.

In a further refinement, an actuating element of the actuating device, in particular a rack, a toothed cord, a rod and/or a plate, can be acted upon, at least partially without a guide rail, by a force for unwinding the roller blind web. In this case, the actuating element can act, for example, centrally on the extension profile. In one embodiment of the actuating element, the latter has sufficient buckling strength in order to prevent noise-generating oscillations of the extended roller blind web. In another embodiment of the invention, further stabilizing means which can be designed such that they are driven or dragged are provided.

In one refinement of the invention, the actuating device comprises a plurality of actuating elements which can be moved in a synchronized manner, with it being possible for the actuating elements to be driven by a common drive and/or by different drives.

In one development, the movement of the actuating elements, for example of the rods, is synchronized by a synchronization shaft. In this case, the drive, for example a geared motor, can be arranged in such a manner that it acts directly on the synchronization shaft which then drives the actuating elements or actuating means. In other refinements, the driving motor is assigned to one of the actuating elements whereas the further actuating elements are driven by the synchronization shaft.

The object is further achieved by means of a method for fitting a side window roller blind, comprising a winding shaft, a roller blind web which is fastened at a first edge to the winding shaft, an extension profile which is operatively connected to a second edge of the roller blind web, which edge lies opposite the first edge, such that the roller blind web can be unwound from the winding shaft by means of the extension profile, an actuating device, wherein the extension profile can be displaced by means of the actuating device, and a drive for driving the actuating device, in a motor vehicle, wherein the drive is fitted to a side door of the motor vehicle in the region directly below a lower border of a window opening. Fitting of the side window roller blind can take place within the scope of preassembly of the side door. By fitting the drive in the region of the window breast, a space remains below the drive for further elements which are to be integrated in the side door.

Further advantages of the invention emerge from the description below of exemplary embodiments of the invention which are illustrated schematically in the drawings. The same reference numbers are used in the drawings for identical or similar components. All of the features and/or advantages emerging from the claims, the description or the drawings, including method steps, structural details and spatial arrangements, may be essential to the invention either on their own or in very varied combinations. Features described or illustrated as part of an exemplary embodiment may also be used in a different exemplary embodiment in order to obtain a further embodiment of the invention.

In the drawings:

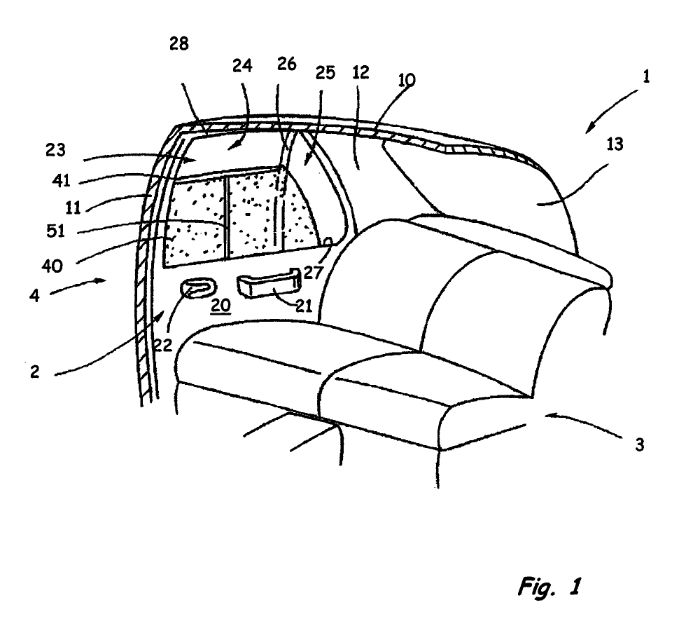

FIG. 1: shows a partially cut open, perspective view of a rear region of a motor vehicle with a view of the inside of the rear, right door;

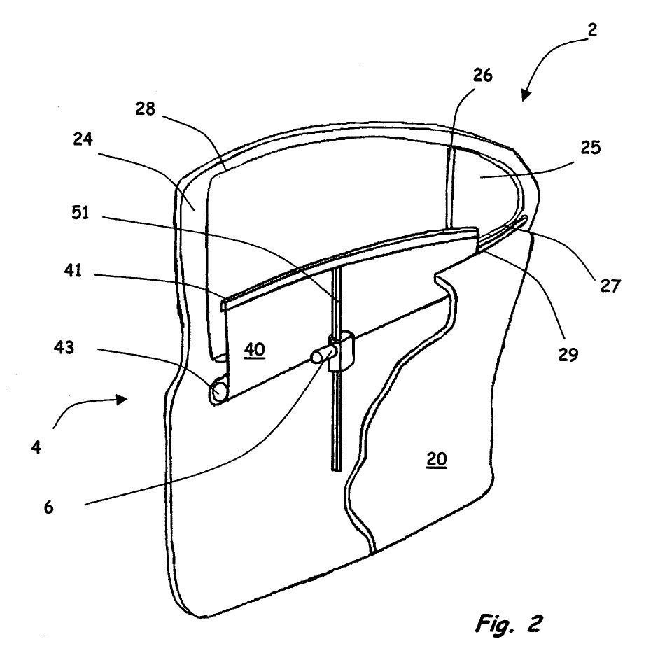

FIG. 2: shows the rear, right door according to FIG. 1 with a side window roller blind according to the invention in accordance with a first exemplary embodiment, in a partially cut open illustration;

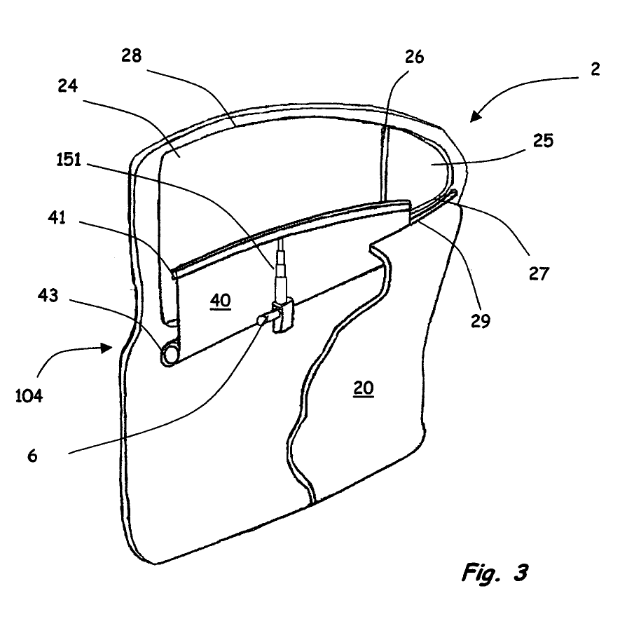

FIG. 3: shows the rear, right door according to FIG. 1 with a side window roller blind according to the invention in accordance with a second exemplary embodiment, in a partially cut open illustration;

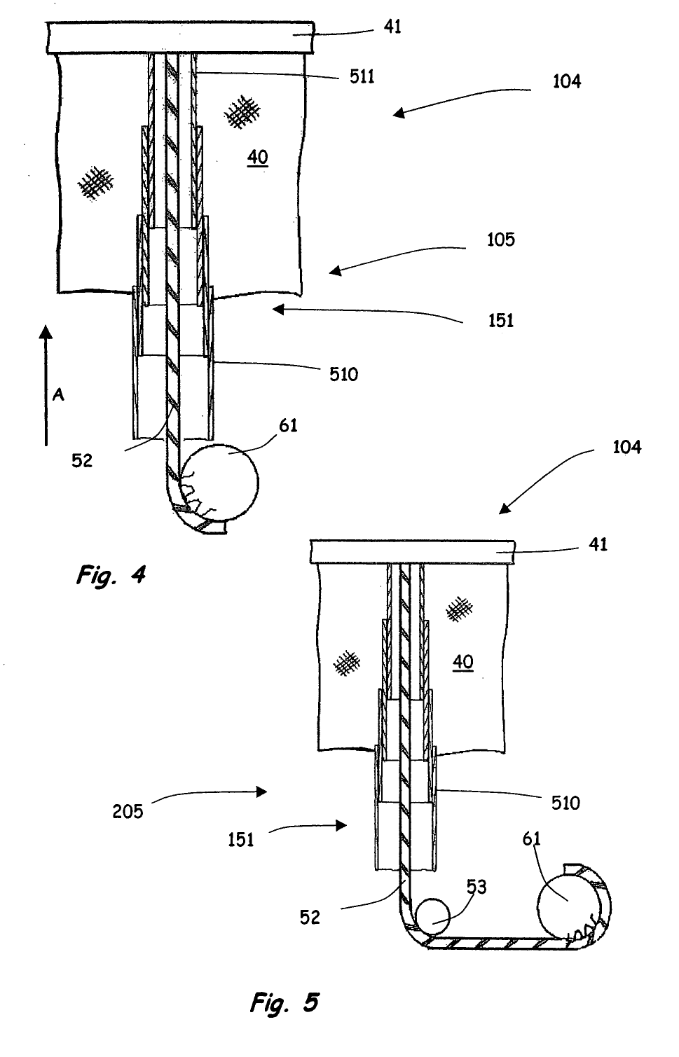

FIG. 4: shows the side window roller blind according to FIG. 3 in a sectioned illustration,

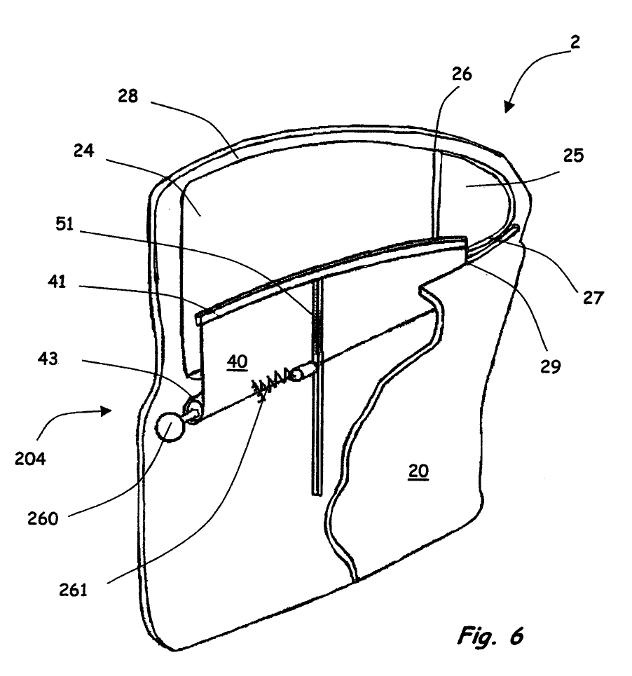

FIG. 5: shows a variant of the side window roller blind according to FIG. 3,

FIG. 6: shows the rear, right door according to FIG. 1 with a variant of the side window roller blind according to FIG. 2;

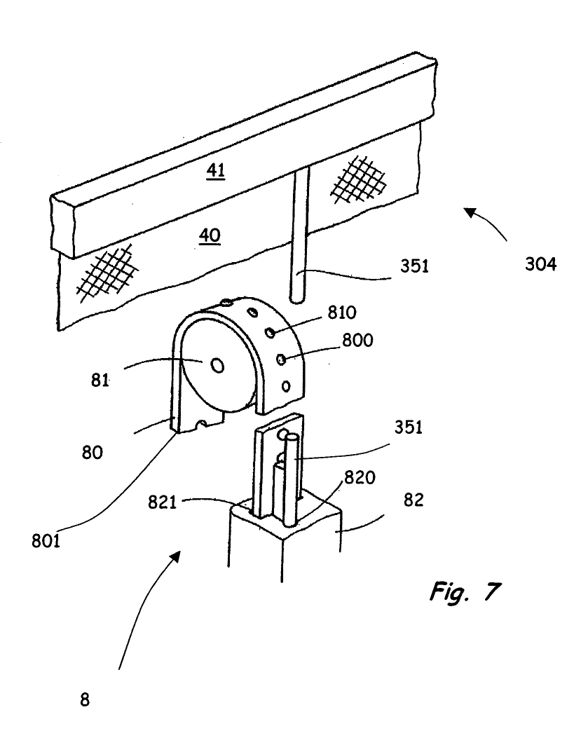

FIG. 7: shows an actuating device of a side window roller blind with a perforated belt drive;

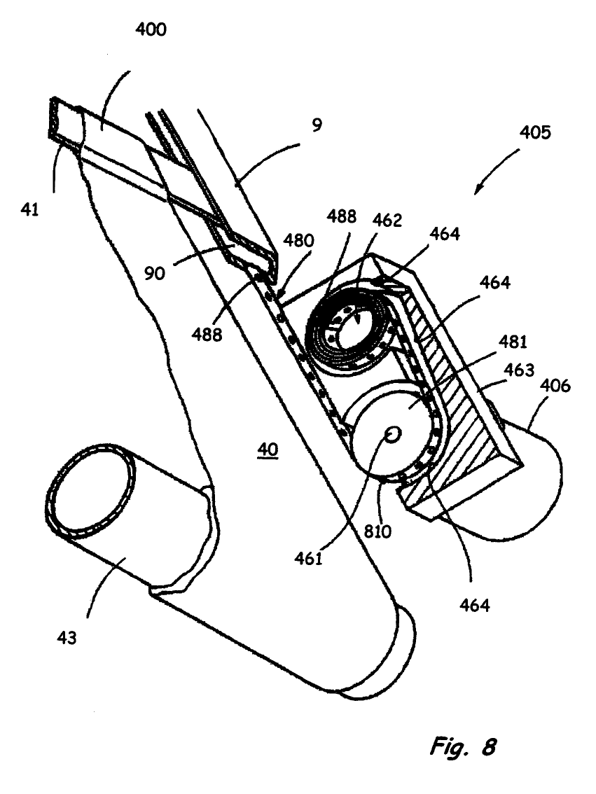

FIG. 8: shows a further variant of an actuating device of a side window roller blind, and

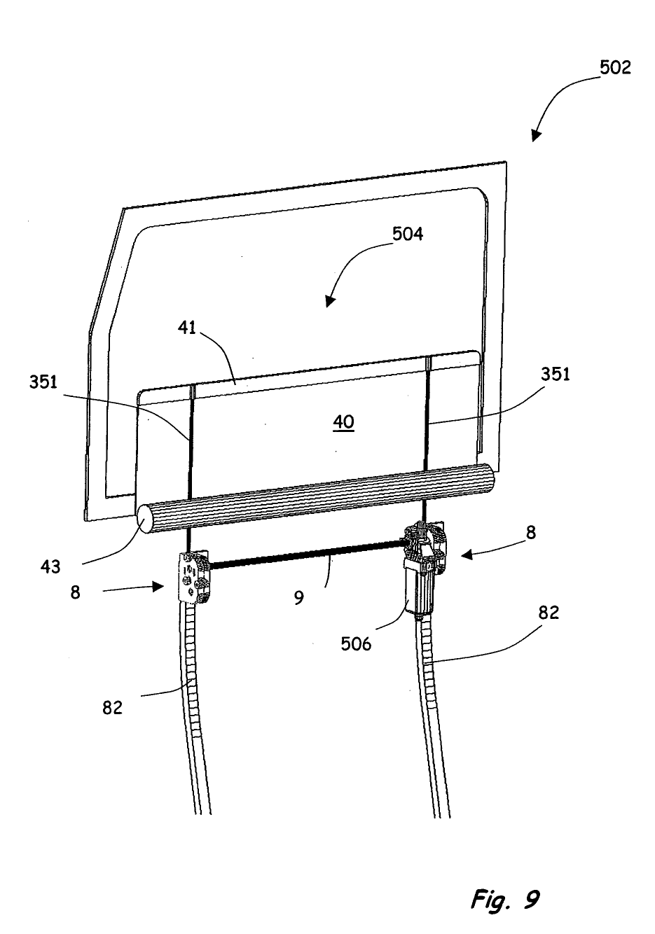

FIG. 9: shows a schematic illustration of a rear, left side door with a further exemplary embodiment of a side window roller blind.

FIG. 1 shows, schematically, a rear region of a motor vehicle 1 in a partially cut open, perspective illustration with a view of the inside of a rear, right side door 2. The motor vehicle 1 has a vehicle roof 10 from which a B pillar 11 of the motor vehicle 1 leads laterally to a floor assembly (not illustrated). As is known, a corresponding B pillar is also provided on the left side (not illustrated in FIG. 1) of the motor vehicle 1. The motor vehicle 1 furthermore has a C pillar 12. The roof 10 merges at a rear edge into a rear window opening 13 into which a rear window (not illustrated) can be inserted. The right, rear side door 2 is fitted in a known manner, in particular mounted on hinges, between the B pillar 11 and the C pillar 12. A rear seat bench 3 is located level with the side door 2.

The inside of the side door 2 that is visible in FIG. 1 and faces an interior of the motor vehicle 1 has an inner lining 20. A door handle 21 and an actuating catch 22 for a door lock (not illustrated) are provided on the inner lining 20. Further elements (not illustrated), such as speakers and the like, can likewise be integrated in the side door 2.

The side door 2 has a window opening 23 which is divided by a web 26 into a first section 24 and a second section 25. In this case, the second section 25 is designed as a “triangular window”, and therefore the window opening 23 is essentially trapezoidal. The window opening 23 has a lower border 27 and an upper border 28, the upper border 28 usually not running parallel to the lower border 27 but being able to run in a curved manner. A two-part side window (not illustrated) can be inserted into the window opening 23. The side window is usually displaceable at least in the first section 24.

Furthermore, the window opening 23 can be darkened by a side window roller blind 4 according to the invention with a roller blind web 40. The side window roller blind 4 according to the invention comprises an extension profile 41 by means of which the roller blind web 40 can be unwound from a winding shaft (not illustrated in FIG. 1). The extension profile 41 can be moved by means of an actuating device. In the exemplary embodiment illustrated in FIG. 1, the actuating device comprises a rack 51.

FIG. 2 shows, schematically, the side door 2 according to FIG. 1. The same reference numbers are used for identical components and a detailed description of said components is omitted. In the illustration according to FIG. 2, the inner lining 20 of the side door 2 is partially cut open. As a result, parts of the side window roller blind 4 that are not visible during normal operation are visible. As can be seen in FIG. 2, the side window roller blind 4 comprises a winding shaft 43 to which the roller blind web 40 is fastened in a manner such that it can be wound up and unwound. In the illustration according to FIG. 2, the roller blind web 40 is only partially unwound. As can be seen in FIG. 2, upon winding onto the winding shaft 43, the roller blind web 40 can be lowered behind the inner lining 20 of the side door 2 via a slot 29. In an advantageous refinement, the roller blind web 40 can be completely lowered behind the inner lining 20. As can be seen in FIG. 2, the extension profile 41 illustrated is curved at least in some sections, and therefore the extension profile 41 can be matched to the profile of an upper border 28 of the window opening 23 to be covered. As a result, good darkening of the associated side window is possible.

The extension profile 41 is operatively connected to the rack 51 for displacing the extension profile and therefore for unwinding the roller blind web 40 from the winding shaft 43. A geared motor 6 (visible in FIG. 2) which has a gearwheel (not visible) for driving the rack 51 is arranged in the region of the lower border 28 of the window opening 23. A length of the rack 51 corresponds essentially to an extension length of the roller blind web 40. The rack 51 requires only a small amount of space on the side door 2 and can thus easily be integrated therein. Owing to the fact that the driving motor 6 is arranged directly on the lower border 28, good introduction of force is possible. In addition, an extended length of the rack 51 is minimized, and therefore a risk of buckling during the extension operation is reduced. In other embodiments (not illustrated) of the invention, instead of a rack 51 a perforated plate and/or another actuating element which has tooth-shaped grooves and/or projections for driving by means of a gearwheel is/are provided. In other refinements, a pneumatically drivable rod is provided for moving the extension profile.

FIG. 3 shows, schematically, the side door 2 according to FIG. 1 with a side window roller blind 104 in accordance with a second exemplary embodiment of the invention. The side window roller blind 104 is similar to the side window roller blind according to FIG. 2 and the same reference numbers are used for identical components. A detailed description of said components is omitted. An actuating device for the side window roller blind 104 comprises a telescopic bar 151 which acts on the extension profile 41 such that, in the embodiment illustrated, the extension profile 41 can be moved in the direction of the upper border 28 of the window opening 23 in order to unwind the roller blind web 40. The telescopic bar 151 illustrated is moved by means of a toothed cord (not visible in FIG. 3). The drive of the toothed cord takes place by means of a driving means, preferably by means of the electric geared motor 6 which is illustrated schematically. As can be seen in FIG. 3, the actuating device according to the invention for the side window roller blind 104 can be constructed in a compact manner and can thus be fitted in the vicinity of the lower border 27 of the window opening.

FIG. 4 shows, schematically, an actuating device 105 for the side window roller blind 104 according to FIG. 3 in a sectioned view. As can be seen in FIG. 4, the telescopic bar 151 has a plurality of tubular telescopic elements or members 510, 511 which are connected to one another in a manner such that they can be displaced one inside another. In the embodiment according to FIG. 4, the telescopic element 511 with the smallest diameter is assigned to the extension profile 41 and is connected thereto. Of course, it is also conceivable to arrange the telescopic bar 151 in a reverse orientation. As can be seen in FIG. 4, a toothed cord 51 is arranged in the telescopic bar 151. In the exemplary embodiment illustrated, the toothed cord 52 is arranged concentrically with respect to the telescopic bar 151. The toothed cord 52 is further connected to the telescopic bar 151 at the telescopic element 511, which is assigned to the extension profile 41, and therefore a movement of the toothed cord 52 in an extension direction A can be transmitted to the telescopic bar 151. The toothed cord 52 is driven by a drive comprising a gearwheel 61, with, in the exemplary embodiment illustrated, when the gearwheel 61 is rotated in the clockwise direction, the toothed cord 52 being displaced in the extension direction A such that the roller blind web 40 is extended. The gearwheel 61 illustrated is formed together with a winding shaft onto which the toothed cord 52 can be wound. The gearwheel 61 is driven by means of an electric motor (not illustrated), with it being possible to provide a gear mechanism (not illustrated) in order to convert a rotational speed and a torque of the electric motor into a rotational speed suitable for the gearwheel 61 and into a desired torque.

FIG. 5 shows, schematically, an actuating device for a side window roller blind 104 with an actuating device 205 in accordance with one variant of the exemplary embodiment according to FIG. 4. The actuating device 205 corresponds essentially to the actuating device 105 according to FIG. 4 and the same reference numbers are used for identical components. A description of said components is omitted. The actuating device 205 according to FIG. 4 additionally comprises a deflecting roller 53 by means of which the toothed cord 52 is deflected. As a result, it is possible to arrange the gearwheel 61 and a drive (not illustrated) at a suitable position on the side door 2 (illustrated in FIG. 3) in order thereby to take structural limitations in a side door 2 into consideration.

FIG. 6 shows, schematically, the side door 2 according to FIG. 1 with a further side window roller blind 204. The side window roller blind 204 is a variant of the side window roller blind 4 according to FIG. 2 and the same reference numbers are used for identical or similar components. A detailed description of said components is omitted. As can be seen in FIG. 6, a geared motor 260 is arranged on the winding shaft 43 of the side window roller blind 204. A spring motor 261 which drives the rack 51 is arranged next to it in the region of the winding shaft 43. As in the embodiment according to FIG. 2, the extension profile 41 is operatively connected to the rack 51 for displacing the extension profile 41 and therefore for unwinding the roller blind web 40 from the winding shaft 43. In the exemplary embodiment illustrated, unwinding takes place on the basis of the force of the spring motor 261. The spring motor 261 may, for example, comprise a spring plate. In order to wind the roller blind web 40 onto the winding shaft 43, the latter is driven by the geared motor 260. Winding up takes place counter to the force of the spring motor 261, and therefore tensioning of the roller blind web 40 is obtained during the winding-up operation.

FIG. 7 shows, schematically, a perforated belt drive 8 of a side window roller blind 304 according to a further exemplary embodiment of the invention. The side window roller blind 304 comprises a roller blind web 40 which is arranged on a winding shaft (not illustrated) in a manner such that it can be wound up and unwound. The free end of the roller blind web 40 is connected to an extension profile 41. Displacement of the extension profile 41 takes place by means of an essentially buckle-proof rod 351 which is also referred to as an antenna. In the exemplary embodiment illustrated, the rod 351 is not guided. However, it is also conceivable to guide the rod 351, for example in a side guide. The rod 351 is operatively connected mechanically to a perforated belt 80 for a transmission of movement. The perforated belt 80 is formed, for example, as a spring steel belt or the like. Besides this, however, it is also conceivable to form the perforated belt from leather or the like. The perforated belt 80 has holes 800 which are arranged at a fixed distance from one another in the longitudinal direction. The perforated belt drive furthermore comprises a disk 81 which can be driven via a drive (not illustrated in FIG. 7). The disk 81 has extensions 810 which engage in the holes 800 of the perforated belt 80 such that the rotational movement of the disk 81 is transmitted to the perforated belt 80. The free end 81 of the perforated belt 80 can be wound onto a roller or the like (not illustrated in FIG. 7). In this case, it is also conceivable to drive a roller (not illustrated) for the winding up of the free end 801 of the perforated belt 80, with it being possible, instead of the directly driven disk 81, to provide a disk which is not driven directly and, on the basis of a winding movement of the perforated belt 80, is dragged. In the exemplary embodiment illustrated, during a movement to retract the roller blind web 40, the rod 351 with the perforated belt 80 fastened thereto is lowered in a receptacle 82 which, for this purpose, has suitable grooves 820, 821. In a different refinement, instead of the perforated belt 80, a cable is provided which, in one exemplary embodiment, is designed as a toothed cord 52 according to FIG. 4.

FIG. 8 shows a further refinement of an actuating device 405 of a side window roller blind, which device comprises a perforated belt 480. The perforated belt 480 is operatively connected directly to an extension profile 41 for unwinding a roller blind web 40 from the winding shaft 43. For this purpose, the perforated belt 480 can have a suitable buckling strength and/or, as illustrated, can be guided in guide rails 9 with grooves 90.

In the embodiment illustrated, the roller blind web 40 has a loop 400 for connection to the extension profile 41, into which loop the extension profile can be pushed. Driving of the perforated belt 480 takes place via a disk 481 with pin-line extensions 810 which project radially from the disk 481. The pin-like extensions 810 engage in corresponding holes 488 of the perforated belt 480. In the exemplary embodiment illustrated, driving of the disk 481 takes place via a drive shaft 461 which is driven by a geared motor 406. Further disks 481 (not illustrated) or other actuating elements can be driven via the drive shaft 461. A free end of the perforated belt 480 is wound up on a roller 462. The disk 461 and the roller 462 are mounted in a housing 463 which has corresponding receptacles 464 for this purpose.

FIG. 9 shows, schematically, a rear, left side door 502 with a side window roller blind 504 in accordance with a further exemplary embodiment of the invention. The side window roller blind 504 has a roller blind web 40 which is arranged on a winding shaft 43 in a manner such that it can be wound up and unwound. An extension profile 41 is provided at the free end of the roller blind web 40. In the exemplary embodiment illustrated, displacement of the extension profile 41 takes place by means of two buckle-proof rods 351 according to FIG. 7. In the exemplary embodiment illustrated, the roller blind web 40 is arranged in front of the rods 351, as viewed from the interior. In other configurations, the direction of rotation of the winding shaft is reversed, as illustrated in FIGS. 2, 3 and 6, and the rods 351 in this case are arranged in front of the roller blind web 40.

The rods 351 are each driven via a perforated belt drive 8 according to FIG. 7. In this case, however, only one geared motor 506 is provided for the direct driving of the perforated belt drive 8, illustrated on the right in FIG. 9. The second perforated belt drive 8, illustrated on the left in FIG. 8, is likewise driven by the geared motor 506, with a transmission of movement taking place by means of a synchronization shaft 7. Of course, it is likewise conceivable to arrange the driving motor 406 on the perforated belt drive 8 illustrated on the left in FIG. 8, or on the synchronization shaft 7 between the perforated belt drives 8. As a result, an arrangement which is optimized in terms of construction space is possible. At the same time, a movement of the side window roller blind 504 is stabilized by the second rod 351. Upon the winding up of the roller blind web 40 onto the winding shaft 43, the rods 351 are lowered in the receiving rails 82 provided for this purpose.

In different variants (not illustrated) of the side window roller blind 504 according to FIG. 9, instead of a perforated belt drive 8, a drive by means of racks 51 according to FIG. 2, by means of a toothed cord 52 according to FIG. 4 or 5 and/or by means of a perforated belt 480 according to FIG. 8 is provided. The actuating means, such as, for example, the rods 351, racks 51 according to FIG. 2, toothed cords 52 according to FIGS. 4 and 5 or perforated belts 480 according to FIG. 8, can furthermore be guided in guide rails or the like.

1. Side window roller blind for a window opening of a motor vehicle, comprising a winding shaft, a roller blind web which is fastened at a first edge to the winding shaft, an extension profile which is operatively connected to a second edge of the roller blind web, which edge lies opposite the first edge, such that the roller blind web can be unwound from the winding shaft by means of the extension profile, an actuating device, wherein the extension profile can be displaced by means of the actuating device, and a drive for driving the actuating device, wherein the drive is at least partially arranged in the region of the winding shaft.

2. Side window roller blind according to claim 1, wherein the drive can be arranged on a side door directly below a lower border of a window opening.

3. Side window roller blind according to claim 1, wherein the drive comprises an electric motor, in particular an electric geared motor.

4. Side window roller blind according to claim 1, wherein the actuating device has at least one elongated actuating means with at least one row of profilings, in particular tooth-shaped grooves and/or projections, the drive comprising an output gear for driving the actuating means, said output gear which having mating profilings, in particular teeth, which correspondingly engage in an interlocking manner in the profilings of the actuating means.

5. Side window roller blind according to claim 4, wherein the actuating device comprises, as the actuating means, at least one rack which is operatively connected to the extension profile for a transmission of movement.

6. Side window roller blind according to claim 5, wherein the rack is flexurally elastic.

7. Side window roller blind according to claim 4, wherein the actuating device comprises, as the actuating means, at least one toothed cord which is operatively connected to the extension profile for a transmission of movement.

8. Side window roller blind according to claim 1, wherein the actuating device comprises, as the actuating means, at least one perforated longitudinal profile, in particular a metal plate, preferably a spring steel belt, which is operatively connected to the extension profile for a transmission of movement.

9. Side window roller blind according to claim 8, wherein the actuating device comprises a cable drive and/or or perforated belt drive by means of which at least one essentially buckle-proof rod of the actuating device can be actuated for the displacement of the extension profile.

10. Side window roller blind according to claim 1, wherein a blank of the roller blind web corresponds at least approximately to a shape of a window opening.

11. Side window roller blind according to claim 1, wherein the actuating means of the actuating device, in particular a rack, a toothed cord, a rod and/or a perforated longitudinal profile, is at least partially guided in a guide rail.

12. Side window roller blind according to claim 1, wherein the actuating means of the actuating device, in particular a rack, a toothed cord, a rod and/or a plate, can be acted upon, at least partially without a guide rail, by a force for unwinding the roller blind web.

13. Side window roller blind according to claim 1, wherein the actuating device has at least two actuating means for displacing the extension profile, with a movement of the actuating means being synchronized.

14. Side window roller blind according to claim 13, wherein a synchronization of the actuating means takes place by means of a synchronization shaft arranged essentially parallel to the winding shaft.

15. Method for fitting a side window roller blind in a motor vehicle, wherein the side window roller blind comprises a winding shaft, a roller blind web which is fastened at a first edge to the winding shaft, an extension profile which is operatively connected to a second edge of the roller blind web, which edge lies opposite the first edge, such that the roller blind web can be unwound from the winding shaft by means of the extension profile, an actuating device by means of which the extension profile can be displaced, and a drive for driving the actuating device, wherein the drive is fitted to a side door of the motor vehicle in the region directly below a lower border of a window opening.
